(19) United States
(12) Patent Application Publication
(10) Pub. No.: US 2026/0176080 A1
(43) Pub. Date: Jun. 25, 2026

(54) Resilient stepped log pusher and method for pushing logs to reduce vibrations and increase durability

(71) Applicant: BID GROUP TECHNOLOGIES LTD., Prince George (CA)

(72) Inventors: Steve Hamel, Saint-Ephrem-de-Beauce (CA); Pierre-Olivier Doyon, Saint-Benoit-Labre (CA); Pierre Faucher, Saint-Georges (CA)

(21) Appl. No.: 19/431,006

(22) Filed: Dec. 23, 2025

Related U.S. Application Data
(60) Provisional application No. 63/738,082, filed on Dec. 23, 2024.

(51) Int. Cl. B65G 27/08

(52) U.S. Cl. CPC B65G 27/08; B65G 2201/0217; B65G 2201/0223; B65G 2207/28

(57) ABSTRACT

A log pusher comprising a frame, a reception bed attached to the frame and a single step assembly moving up and down with regard to the reception bed. The single step comprises a resilient member for absorbing and/or reducing vibrations associated with logs impacting the log pusher. A method to reduce vibrations associated with logs impacting a log pusher is also provided. The pusher may also be replaced in a log production line using a crane or any other similar equipment.

### CROSS-REFERENCE TO RELATED APPLICATIONS

The present patent application claims the benefits of priority of US Provisional Patent Application No. U.S. 63/738,082, entitled “RESILIENT STEPPED LOG PUSHER AND METHOD FOR PUSHING LOGS TO REDUCE VIBRATIONS AND INCREASE DURABILITY”, and filed at the US Patent Office on Dec. 23, 2024, the content of which is incorporated herein by reference.

### FIELD OF THE INVENTION

The present invention generally relates to systems to push and straighten logs in log production line and to methods for pushing logs. More particularly, the present invention relates to log pushers having increased durability and vibration absorption and method for pushing logs while absorbing vibrations and increasing durability.

### BACKGROUND OF THE INVENTION

Log pushing machines are essential equipment in the logging industry, used to transport logs from one location to another. These machines are subjected to repeated impacts from logs, which can lead to wear and tear over time.

The prior art log pushing machines have limited lifespan due to the repeated impacts from the logs. Furthermore, the prior art log pushing machine generally requires labor-intensive replacement process. Current systems for pushing logs require the entire machine to be replaced when the pusher breaks. Such replacement is a labor-intensive and time-consuming process. The rolling elements of existing pusher are generally affected by uneven wear and tear. The hyperstatic nature of the linear systems of existing pushers does not allow for any misalignment, leading to uneven wear and tear of the rolling elements.

To address this such issues, current log pusher are generally reinforced. However, even with the reinforcements, the machines eventually break due to the hyperstatic nature of the linear systems, which does not allow for any misalignment. As a consequence, the rolling elements are rapidly affected by wear and tear leading to frequent replacements and downtimes.

There is thus a need for an improved log pusher and method of pushing logs which overcome the drawbacks of the existing log pushers. More specifically, there is a need for a log pushing system reducing tear and wear of the rolling elements, reducing process of replacement of part being affected by wearing and thus having an increased lifespan.

### SUMMARY OF THE INVENTION

The shortcomings of the prior art are generally mitigated by an improved log pushing system reducing tear and wear of the rolling elements, reducing process of replacement of part being affected by wearing and thus having an increased lifespan.

In one aspect of the invention, a log pusher is provided. The log pusher may comprise reinforcements made of materials of high strength and durability. However, despite such reinforcements, the pushers may still face issues of limited lifespan due to the repeated impacts from logs. The stepped pusher generally aims at increasing the lifespan of the pusher by making them easier to replace and reducing the impact of repeated log strikes. The log pusher generally simplifies the replacement process by comprising a stepped pusher easily movable, and thus replaceable, with a crane. The use of a crane generally reduces the downtime and labor costs associated with such replacement.

The log pusher may further comprise a spring-mounted wheel in the stepped pusher, providing each step with a degree of freedom allowing absorption of vibrations caused by repeated impacts. The spring-mounted wheel may further prevent misalignment, thereby aiming at reducing the wear and tear of the rolling elements.

Compared to prior art systems, the present invention generally aims at solving limited lifespan of reinforced pushers. While the present invention is made with materials having high strength and durability properties, lifespan of the system may be limited due to repeated impacts from logs. The present invention comprises a stepped pusher design and aims at increasing lifespan of pushers by making them easier to replace and reducing the impact of repeated log strikes.

The present invention further aims at reducing the labor-intensive process of replacing a log pusher. Prior art log pushers requires the entire machine to be replaced when the same is broken or present important wears. Such replacement process is labor-intensive and time-consuming. The present invention aims at reducing labor associated with the replacement process. As such, a stepped log pusher being easily replaceable using a crane is provided. The present stepped log pusher generally reduces downtime and labor costs associated with the replacement process.

The durability properties, lifespan of the system may be limited due to repeated impacts from logs. The present invention comprises a stepped pusher design and aims at increasing lifespan of pushers by making them easier to replace and reducing the impact of repeated log strikes.

The present invention also aims at reducing uneven wear and tear of rolling elements of the log pusher. Prior art log pusher are associated with linear systems having an hyperstatic nature. The hyperstatic properties does not allow misalignment or variations. As such, to the rolling elements starts to unevenly wear and tear. The present invention comprises a resilient portion, typically implemented with a spring-mounted wheel within the stepped pusher. Such resilient portion generally aims at adding a degree of freedom to absorb vibrations caused by repeated impacts and prevent misalignment, thereby reducing the wear and tear of the rolling elements.

In order to achieve the above objectives, a log pusher in accordance with the principles of the present invention may be associated with a stepped pusher design. Such design generally allows easier replacement of the pusher with the help of a crane or any other similar equipment to move a load. The stepped pusher design generally reduces labor-intensive and time-consuming process associated with replacing the entire machine when the pusher system breaks. The step in the pusher design also provides more space underneath the machine, making it easier to access and maintain.

In one aspect of the invention, the log pusher comprises a resilient portion, such as but not limited to a spring-mounted wheel. The log pusher comprises the resilient member or spring-mounted wheel to add to the step a degree of freedom of movement. As such, the wheel can absorb vibrations caused by repeated impacts from logs, reducing the impact on the pusher and preventing misalignment. The resilient member further allows reducing uneven wear and tear of the rolling elements in the linear systems, which is caused by the hyperstatic nature of prior art systems.

In another aspect of the present invention, the log pushers is made with materials having high strength and increased durability to increase lifespan of the log pushers. The selection of the materials is based on ability of the materials to withstand repeated impacts from logs without breaking. The use of strong and durable materials combined with the stepped pusher design and the resilient member contributes to increase the overall longevity and efficiency of the machine.

In a further aspect of the invention, a single step log pusher for absorbing vibration from logs is provided. The log pusher comprises a frame, a reception bed attached to the frame to receive a plurality of the logs, a drive system, a single step assembly driven by the drive system and configured to move up and down about the reception bed. The single step assembly comprises a sliding member movable upwardly and downwardly by the drive system, a guiding assembly guiding movement of the sliding member comprising at least one shock absorber configured to reduce vibration from the movement of the received logs.

The shock absorber may be connected to at least one cam forwarder of the guiding assembly. The cam forwarders may be attached to the frame with the resilient member. The resilient member may be a spring. The resilient member may further be rigid rubber.

The single step assembly may be detachable from the frame or the reception bed may be detachable from the frame. The attachment members may be hooks. The reception bed may further comprise a plate made out of polyurethane.

In yet another aspect of the invention, a single step log pusher is provided. The single step log pusher comprises a frame, a reception bed detachably attached to the frame to receive a plurality of the logs, a drive system and a single step assembly driven by the drive system and configured to move up and down about the reception bed, the single step assembly being detachably attached to the frame.

The single step log pusher may comprise a crane attachment system. The crane attachment system may comprise attachment members for attaching the reception bed and the single step assembly. The attachment members may be hooks.

In another aspect in of the invention, a method to reduce vibrations associated to operation of a log single step device is provided. The method comprises receiving a plurality of the logs to form a line, upwardly pushing a first of the logs in line and absorbing vibrations associated with the pushing of the logs or other vibrations created by the reception of the logs.

The pushing of the log may be performed by a pushing member using guiding members, the guiding members absorbing the vibrations. The guiding members may absorb the vibration with resilient members.

In a further aspect in of the invention, a method for replacing a component of a log pusher in a log production line is provided. The method may comprise detaching a component from a frame of the log pusher, attaching a lift system to an attachment member of the detached component and lifting the attached component, replacing the component with a replacement component using the lift system, removing the lift system from the replacement component and connecting the replacement component to the log pusher.

The method may further comprise inserting a replacement component in an area left empty by the lifted component. The lifted component may be a single step assembly or a reception bed.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a perspective view of an embodiment of a single step log pusher in accordance with the principles of the present invention.

FIG. 2 is sectional side view of an embodiment of a reception in accordance with the principles of the present invention.

FIG. 3 is sectional side elevation view of an embodiment of a cam assembly comprising a spring of the log pusher of FIG. 1.

FIG. 4 is sectional perspective front view of an embodiment of a single step log pusher in accordance with the principles of the present invention.

FIG. 5 is sectional perspective rear view of an embodiment of a single step log pusher in accordance with the principles of the present invention.

### DETAILED DESCRIPTION OF THE INVENTION

A novel resilient stepped log pusher and method for pushing logs to reduce vibrations and increase durability will be described hereinafter. Although the invention is described in terms of specific illustrative embodiments, it is to be understood that the embodiments described herein are by way of example only and that the scope of the invention is not intended to be limited thereby.

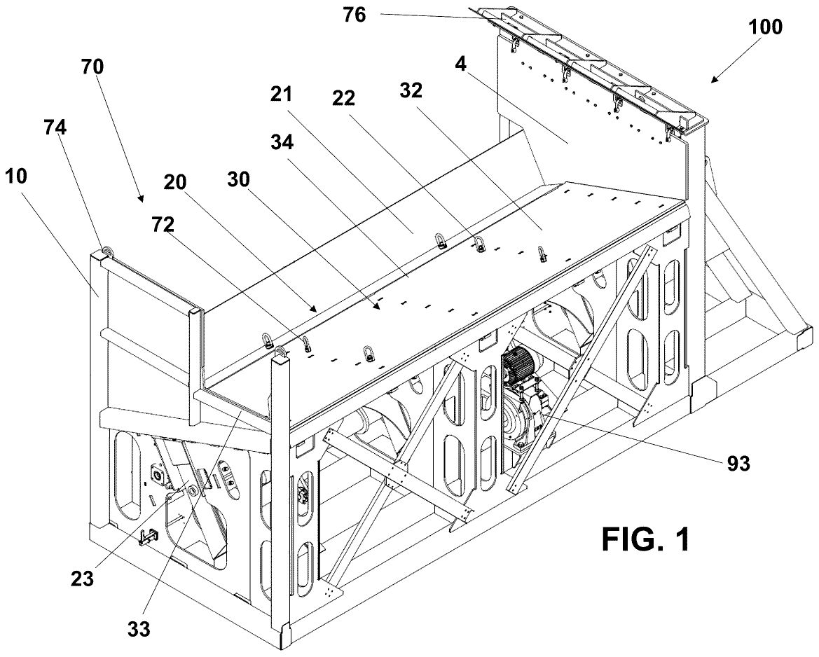

Referring now to FIG. 1, an embodiment of a single log pusher 100 is illustrated. The log pusher 100 comprises a frame 10, a reception bed 30 attached to the frame 10 and a single step assembly 20 moving up and down with regard to the reception bed 30. The frame 10 is made of rigid and durable material known in the art, such as but not limited to high strength steel.

The reception bed 30 is typically uses to receive a plurality of logs from another processing machine located upstream in the production line. The reception bed 30 is generally adapted to absorb vibrations created by operation of the log pusher 100 or from logs being moved. The reception bed 30 typically comprises a slanted flat surface 32 adapted to receive logs and to move the received log by gravity toward the single step assembly 2. In the illustrated embodiment, the reception bed 30 comprises an input side 33 and an output side 34. As such, the log to be pushed is received by the input side 33 and slide or move down toward the output side adjacent to the single step assembly 2.

The reception bed 30 is further adapted to reduce transfer of vibrations to the frame 10. As the vibrations are transferred to the frame 10, durability of the reception bed 30 may be improved. The reception bed 30 is also made of rigid and durable material known in the art, such as but not limited to high strength steel.

The single step assembly 20 is generally adapted to received one or more logs from the reception bed 30, to move or push up the one or more received logs, to discharge the moved or pushed logs and to move down back to a reception position when the pushed log has been discharged. The single step assembly 20 aims at singularizing the logs to bring the logs one at a time for further processing downstream of the production line. Understandably, singularizing may mean isolating a single log or a plurality of logs from the logs being received on the reception bed.

The illustrated single step assembly 20 comprises a reception bay comprising an end wall 21 and a base surface 22. The base surface 22 is generally at the same angle as the flat surface 32 of the reception bed 30. The end wall 21 and the base surface 22 are typically orthogonal and sized to allow a single log to fit in the reception bay. The single step assembly 20 further comprises one or more pushing members 20 driving by a drive system 9. The drive system 9 may comprise a rotating shaft 92 and link arms 94 connected to the pushing members 20 to move the single step assembly 20 up and down.

The log pusher 100 may further comprise a stop wall 4 adapted to stop longitudinal movement of the log entering the reception bed 20 of the log pusher 100. The stop wall 4 typically receive an end section of the log being singularized. The stop wall 4 is also made of rigid and durable material known in the art, such as but not limited to high strength steel, to resist to repeated impacts of logs.

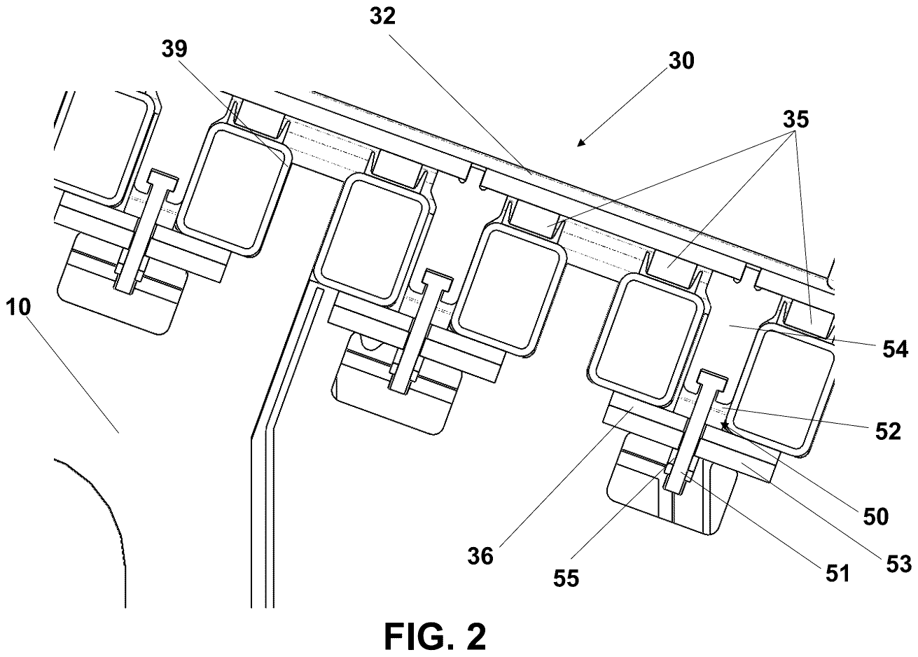

Referring now to FIG. 2, a sectional side view of an embodiment of a reception bed 30 is illustrated. In such embodiment, the top surface 32 is mounted to a plurality of supporting members 39. The reception bed 30 comprises resilient members 35 adapted to absorb shocks or vibration caused by logs. The resilient members 35 are typically inserted between the top surface 32 and the supporting members 39. The resilient members 35 may be made of polyurethane or other resilient yet durable material.

The reception bed 30 may further comprise lower resilient members 36 also adapt to absorb shocks or vibration caused by supporting members 39. The supporting members 39 are preferably solidly attached or connected to the frame 10. The lower resilient members 36 generally limit bouncing due to the top surface 32 reverting back to an initial position after absorbing a vibration or a shock. The lower resilient members 36 may also be made of polyurethane or other resilient yet durable material.

The reception bed 30 may further comprise a movable assembly 50. The movable assembly 50 generally absorbs vertical movement of the reception bed 30. In the illustrated embodiment, the movable assembly 50 comprises a pin or bolt 51 freely moving through the lower resilient member 36 and a bottom plate 53. The pin 51 may comprise a fastener 55 limiting the movement through the lower resilient member 36 and the bottom plate 53. The fastener 55 may be a nut and a thread of the pin 51. The top of the pin 51 is attached to the top surface 32, such as through a rigid or link member 54. The rigid member 54 is typically inserted between two supporting members 39 and attached to the top surface 32. In such embodiment, the rigid member allows attachment of the pin 51 to the top surface 32 without having the pin 51 passing through the top surface 32. As illustrated, a head of the pin 51 is inserted within the rigid member 54. The movable assembly 50, at rest, forms an empty space 52 allowing for movement of the reception bed 30.

The reception bed 30 is typically attached with a plurality of the fasteners 55. As such, to detach the reception bed 30 from the system 100, one may remove all fasteners 55, attach hooks 72 to the reception bed 30, such as but not limited to the supporting members 39. When detached, the reception bed 30 may be lifted in order to be replaced or repaired.

Referring now to FIGS. 1 and 2, an embodiment of the reception bed 30 and of a single step assembly 20 is illustrated. In such embodiment, the reception bed 30 comprises a plate 32 adapted to receive the incoming logs. The plate 32 is typically attached to the frame 10 through a resilient member to absorb vibration, such as but not limited polyurethane. In such embodiment, the plate 32 is solidly attached to the reception bed 30 without being welded. In a preferred embodiment, the plate 32 is embedded or recessed in the reception bed 30. The embedded aspect generally aims at reducing stress on the welding line, which may become cracked after repeated impacts from logs. Understandably, any other attachment means without welding are within the scope of the present invention.

Furthermore, the FIG. 2 illustrates attachment of the reception bed 30 to the frame 10. The attachment assembly generally allows the reception bed 30 to be detached from the frame 10 when reaching end of life. As discussed below, in some embodiments, the reception bed 30 may be replaced without replacing the complete log pusher system 1. Understandably, any other attachment assembly which may be easily detached may be used within the scope of the present invention.

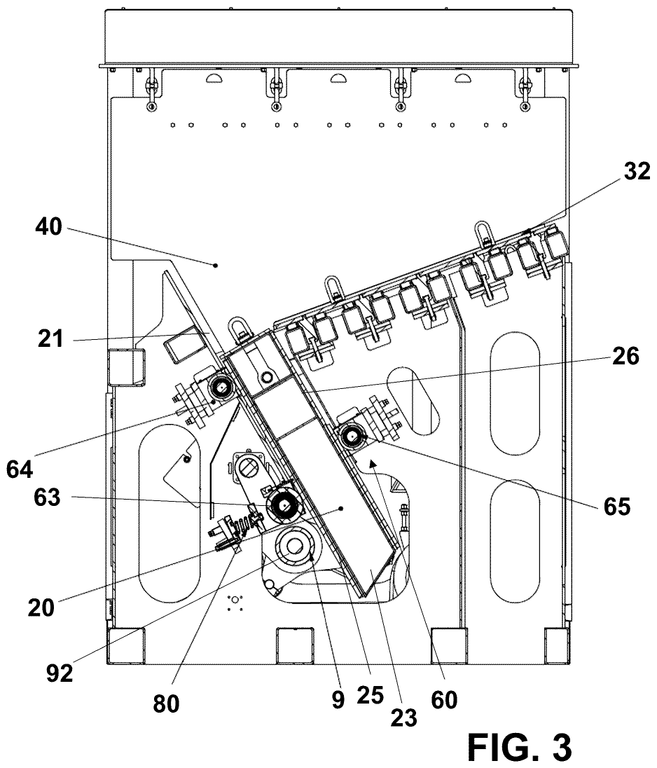

Referring now to FIGS. 3-5, an embodiment of the single step assembly 20 is illustrated. In such embodiment, the single step assembly 20 comprises a guiding assembly 60. In such embodiment, the guiding assembly 60 comprises cam followers 63, 64 and 65. The cam followers 63, 64 and 65 generally allow rolling of the sliding member 23 within the single step assembly 20. In the illustrated embodiment, two cam followers 63 and 64 supports a first side 25 of the sliding member 23 and a third cam 65 guides the second side 26 of the sliding member 23.

In such embodiment, the single step assembly 20 is stable when moving without being over constrained. The guiding assembly 60 allows movements substantially perpendicular to the up and down directions. As such, the guiding assembly 60 has a loose fit within the single step assembly 20 to absorb vibrations or shocks. In the illustrated embodiment, at least one 63 of the cam followers comprises a resilient assembly 80, such as but not limited to a spring or a rigid rubber. The resilient assembly 80 generally aims at reducing vibrations associated with movement of the logs. The resilient assembly 80 further provides a degree of freedom of movement. The resilient assembly 80 is generally provided to bear for any manufacturing imprecision and to improve the lifespan of the single step assembly 20 but limiting friction between the sliding member 23 and the inner walls of the single step assembly 20 created by vibrations. The resilient assembly 80 further allows any debris or smaller portion to move down between the single step assembly 20 and the frame 10. By moving out of the system 100, the debris are less prone to damage the system or to jam the single step assembly 2, thus increase durability and reliability of the log pusher 1.

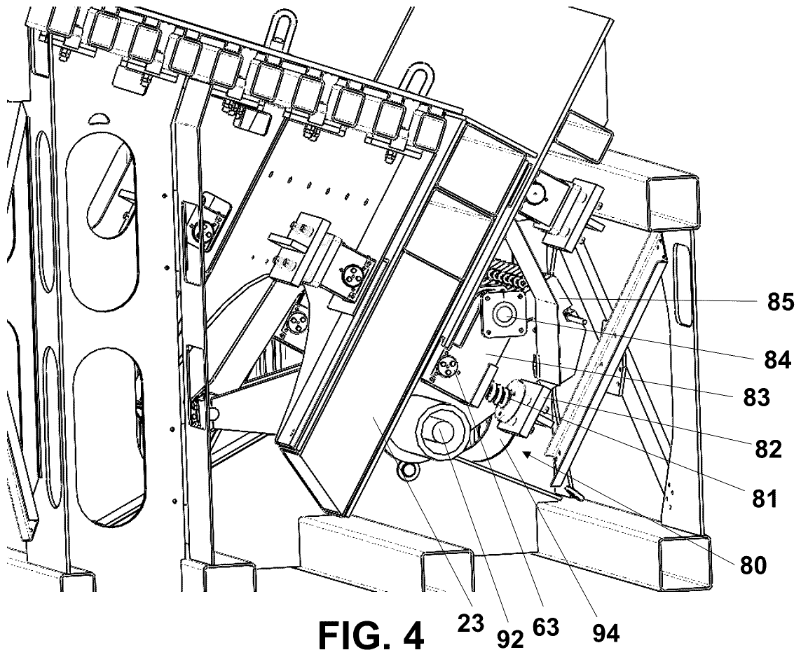

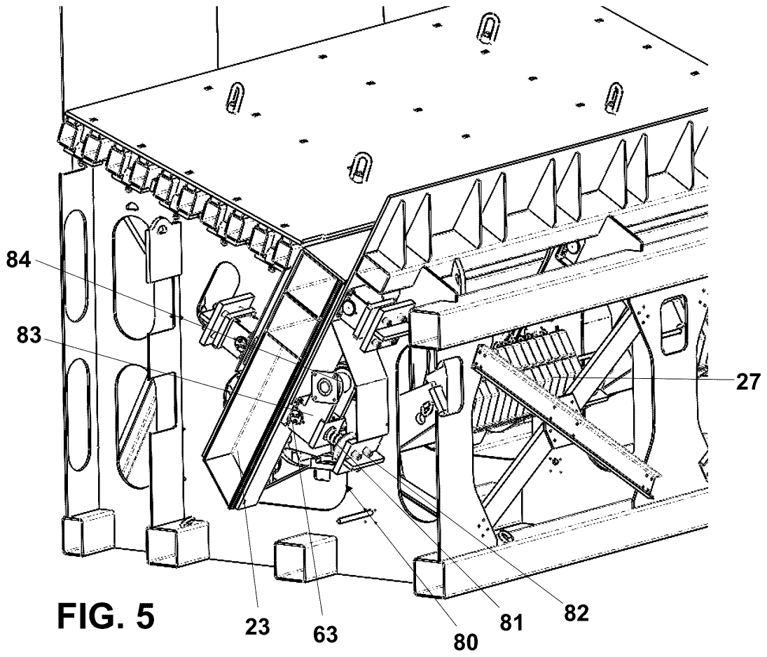

Referring now to FIGS. 4 and 5, the resilient assembly 80 comprises a resilient member 81, such as a spring, attached between plate 82 and link arm 83. The plate 82 is fixed to the frame 10 or any structural element. The link arm 83 is pivotally attached to the frame 10 through a pivot point 84 to allow the single step assembly 20 to absorb shock or vibrations. The cam forwarder 63 is attached to the link arm 83 in order to move upon a vibration or shock. Understandably, any other mechanism or means for the cam forwarder 63 to absorb a force or impact are within the scope of the present invention, such as but not limited to, a block of rigid rubber replacing the spring or holding the cam forwarder 63. Also, more than one cam forwarder may comprise or be connected to a resilient assembly 80.

In some embodiments, the single step assembly 20 comprises a counterweight 27 to counterbalance the weight of the sliding member 23 moving up and down. In other embodiments having multi-steps, a second single step assembly 20 (not shown) can be connected to be used as a counterweight for the operation of the first single step assembly 20.

Referring back to FIGS. 3-5, the single step assembly 20 further comprises a drive system 9 inducing upward and downward movement of the single step assembly 2. In the illustrated embodiment, the drive system 9 comprises a rotative mechanism 92 and links arms 94 to move the single step 2. Understandably, the drive system 9 shall comprise any known motor or other driver 93 to rotate the rotative mechanism 92.

While the disclosed log pusher 100 is made of a single pusher assembly 20, other embodiments having more than one pusher assembly 20 are within the scope of the present invention. As such, the log pusher 100 may allow to singularize and move the logs up at a higher height. In such embodiment, each single pusher assembly 20 of each step may comprise a resilient assembly 80 reducing the vibrations. In other embodiments, only one of the pusher assembly 20 may comprise a vibration absorber 80 and other may be embodied as known in the art pusher assembly.

The components of the log pusher system 100 are adapted to be easily detached and moved out of the log pusher system 100, namely of the frame 10. As such, in some embodiments, the log pusher system 100 may comprise a crane attachment system 70. In the illustrated embodiment, the crane attachment system 70 comprises reception bed hooks 72, frame hooks 74 and top hooks or handles 76. Each of the hooks 72, 74 or 76 are solidly attached to the components of the log pusher 100 in order to rise and transport the components of the log pusher 100 out of the production line. In a preferred embodiment, the pusher assembly 20 may be detached from the frame assembly 10. As such, when the step pusher assembly 20 comprises wears and tears, one may easily detach the step assembly 20, rise it with a crane or similar equipment and remove the same from the log pusher 100. A replacement step assembly 20, preferably in working order, may be moved to the log pusher 100 and installed in the area left free by the removal of the old step assembly 20. The same process may be performed for other components of the log pusher 100, such as the bed assembly 20. Understandably, any other method to attach components of the log pusher 100, such as the step assembly 20, may be used within the scope of the present invention.

A method for pushing or singularizing logs to reduce vibrations and increase durability is also provided. The method generally comprises receiving logs in a reception bed, upwardly moving a single log at a time while absorbing vibrations associated with the log's impacts.

A method for replacing one or more components of a log pusher 100 is also provided. The method generally comprises disconnecting a component, such as the reception bed 30 or the single step assembly 20 from the frame 10 of the log pusher 1000. The components may comprise but are not limited to the step assembly 20 or the reception bed 30. The method further comprises attaching a crane or other similar equipment to an attachment member of the component to be replaced. The method further comprises rising the attached component and moving the lifted component out of the log pusher 100. The method may further comprise moving a component in working condition over the position of the component being replaced, lowering the attached component in the now free area where the new component shall be installed, detaching the crane from the component and connecting the component to the log pusher 100. As such, any component of the log pusher 100 may be replaced without having modify or replace the frame 10 of the log pusher 100. Such method greatly reduces the efforts required to repair or maintain a log pusher system 100 in a log production line.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A single step log pusher for absorbing vibration from logs, comprising:
a frame;
a reception bed attached to the frame to receive a plurality of the logs;
a drive system;
a single step assembly driven by the drive system and configured to move up and down about the reception bed comprising:
a sliding member movable upwardly and downwardly by the drive system; and
a guiding assembly guiding movement of the sliding member comprising at least one resilient member configured to reduce vibration from the movement of the received logs.

2. The single step log pusher of claim 1, the resilient member being connected to at least one cam forwarder of the guiding assembly.

3. The single step log pusher of claim 2, the cam forwarders being attached to the frame with the resilient member.

4. The single step log pusher of claim 3, the resilient member being a shock absorber.

5. The single step log pusher of claim 4, the shock absorber comprising a spring.

6. The single step log pusher of claim 4, the shock absorber comprising rigid rubber.

7. The single step log pusher of claim 1, the single step assembly being detachable from the frame.

8. The single step log pusher of claim 1, the reception bed being detachable from the frame.

9. The single step log pusher in claim 1 wherein the reception bed further comprise a plate made out of polyurethane.

10. A single step log pusher comprising:
a frame;
a reception bed detachably attached to the frame to receive a plurality of the logs;
a drive system; and
a single step assembly driven by the drive system and configured to move up and down about the reception bed, the single step assembly being detachably attached to the frame.

11. The single step log pusher of claim 10 comprising a crane attachment system.

12. The single step log pusher of claim 11, the crane attachment system comprising attachment members for attaching the reception bed and the single step assembly.

13. The single step log pusher of claim 12, the attachment members being hooks.

14. A method to reduce vibrations associated to operation of a log single step device comprising:
receiving a plurality of the logs to form a line;
upwardly pushing a first of the logs in line; and
absorbing vibrations associated with the pushing of the logs or other vibrations created by the reception of the logs.

15. The method of claim 14, the pushing of the log being performed by a pushing member using guiding members, the guiding members absorbing the vibrations.

16. The method of claim 15, the guiding members absorbing the vibration with resilient members.

17. A method for replacing a component of a log pusher comprising:
detaching a component from the log pusher;
attaching a lift system to an attachment member of the detached component;
lifting the attached component;
replacing the component with a replacement component using the lift system; and
connecting the replacement component to the log pusher.

18. The method of claim 17 further comprising inserting the replacement component in an area left empty by the lifted component.

19. The method in claim 17, the lifted component being a single step assembly or a reception bed.
